(19) United States
(12) Patent Application Publication
(10) Pub. No.: US 2026/0253085 A1
(43) Pub. Date: Aug. 27, 2026

(54) COMPUTER IMPLEMENTED SYSTEM AND METHOD FOR AUTHENTICATING DOCUMENTS

(71) Applicant: Mark POIDEVIN, Ellenbrook Western Australia (AU)

(72) Inventor: Mark POIDEVIN, Ellenbrook Western Australia (AU)

(21) Appl. No.: 18/878,097

(22) PCT Filed: Jun. 28, 2023
(86) PCT No.: PCT/AU2023/050595

§ 371 Date: Dec. 23, 2024

(30) Foreign Application Priority Data
Jun. 29, 2022 (AU) 2022901816

(51) Int. Cl. G06Q 30/018; G06Q 10/1053; G06V 40/16; H04L 9/40

(52) U.S. Cl. CPC G06Q 30/018; G06Q 10/1053; G06V 40/172; H04L 63/0435; H04L 63/0442

(57) ABSTRACT

The present invention relates to a system and method enabling users to confirm any formally or officially recognised qualification, certification and/or accreditation associated with an individual as maintained by various entities, including Government or professional/trade organisations. More particularly, the system and method of the present invention enables users to quickly and easily verify the claim(s) of an individual regarding their formally or officially recognised qualification, certification and/or accreditation with prompt confirmation of same, including the status of any such qualification, certification and/or accreditation.

### FIELD OF THE INVENTION

The present invention relates to a system and method enabling users to confirm any formally or officially recognised qualification, certification and/or associated with accreditation an individual as maintained by various entities, including Government or professional/trade organisations. More particularly, the system and method of the present invention enables users to quickly and easily verify the claim(s) of an individual regarding their formally or officially recognised qualification, certification or accreditation with prompt confirmation of same, including the status of any such qualification, certification or accreditation.

### BACKGROUND OF THE INVENTION

Verification regarding the existence of documents including educational qualifications, licences, including driver and boating licences, shooting/firearms licences, trade/industry licences and the like, is a time consuming process. In this regard, verification of the existence of such documents often requires individuals and organizations (e. g, employers of potential employees and/or contractors) to contact the issuer of documents to verify that a claimed qualification, certification or accreditation is valid and that an individual presenting same (e. g a license or certification/accreditation holder) does in fact have the necessary or stated qualification, certification or accreditation.

Issuers of such documents include, for example, Government authorities/departments, police authorities, educational institutions and training organisations. Such entities are usually large organizations and therefore, have detailed processes for issuing information, including requirements for the submission of oral or written requests that state the purpose of the request and that also demonstrate the necessary standing of the requestor to be provided with such information. In this regard, it is possible that privacy considerations may prevent some requestors accessing information regarding a particular qualification/certification/accreditation of an individual particularly if they are able to demonstrate a valid reason for requiring access to such information.

Due to the complex nature of current processes for requesting information that verifies the existence of documents such as qualifications and licenses, many individuals and organizations elect to forego this verification process and elect to rely upon sighting a document (eg, a vehicle driver license, certificate, etc) to establish whether a presenting individual has a claimed qualification/certification/accreditation. However, due to advances in digital technology, it is now relatively easy to produce fraudulent documents of high quality. Accordingly, the ability to verify the authenticity of a document solely by sight is not a sufficient or effective means to establish whether an individual has a necessary or stated qualification/certification/accreditation. Accordingly, individuals are left with no alternative but to contact the issuer of a presented document in order to establish the validity regarding any claimed qualification or certification or accreditation.

A further problem associated with current processes for confirming the existence of documents by written means, and in particular, by the submission of online forms requesting the required information, is wastage of processing (network and memory) resources. For example, wastage of such resources occurs in instances where access to information is denied based on the requestor being unable to establish sufficient standing to be provided with such information, or when information regarding an individual is unable to be provided in instances where identification of the individual that is the subject of the request cannot be established due to lack of information or the provision of incorrect information.

Accordingly, there exists a need for a system and method that is able to provide individuals and organizations with the ability to quickly and easily verify the existence of formally or officially recognized qualifications, certifications, accreditations, or any other type of award maintained by various entities including Government, professional and industry organisations.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for confirming a qualification, certification and/or accreditation of an individual, the method including, receiving, by one or more processors, information from one or more organisations pertaining to qualifications, certifications and/or accreditations of a plurality of individuals whose information is maintained by the organization(s), receiving, by one or more processors, a request from an individual of the plurality of individuals to establish an account, the request including at least one personal image of the individual, processing, by one or more processors and using one or more facial recognition techniques, the at least one personal image of the individual to determine metrics defining the individual in the personal image provided, establishing, by one or more processors, an identification for the individual based at least on the facial recognition metrics, the identification linking the account established for the individual with the information received from organisations pertaining to qualifications, certifications and/or accreditations associated with the individual, the identification stored in a data structure, receiving, by one or more processors, a request from a user to confirm a qualification, certification and/or accreditation of the individual, the request including an image of the individual, processing, by one or more processors, the request and the image of the individual and utilizing the data structure to locate and retrieve the identification corresponding to the individual, and providing, by one or more processors, the user with confirmation or otherwise regarding the qualification, certification and/or accreditation of the individual based on the qualification, certification and/or accreditation recorded for the identification corresponding to the individual.

In an embodiment, the confirmation provided to the user regarding the qualification, certification and/or accreditation confirms the existence and/or current status of the qualification, certification and/or accreditation.

In an embodiment, the method further includes, based on confirmation that the qualification, certification and/or accreditation does exist and is currently valid, providing a recommendation to the user to accept the individual's stated qualification, certification and/or accreditation.

In an embodiment, the method further includes, based on confirmation that the qualification, certification and/or accreditation does not exist and/or is not currently valid, providing a recommendation to the user to reject the individual's stated qualification, certification and/or accreditation.

In an embodiment, the qualification, certification and/or accreditation pertaining to the individual includes one or more of, a professional or industry qualification, an educational qualification, a qualification for driving a vehicle, a police check status, a working with children clearance check status, a medical licence, a mining certification, a passport status, a building industry qualification, a real estate licence, and a sport, recreation and/or firearm licence or certification.

In an embodiment, the metrics defining the individual in the personal image are generated using one or more facial recognition algorithms. The facial recognition algorithms may be implemented by use of the Amazon Recognition and Microsoft Azure Application Programming Interfaces.

In an embodiment, the method further includes, receiving, by one or more processors, updated information from the one or more organisations pertaining to qualifications, certifications and/or accreditations of the plurality of individuals whose information is maintained by the organization(s), and updating, by one or more processors, the identifications associated with the plurality of individuals whose information pertaining to qualifications, certifications and/or accreditations have been updated.

In an embodiment, the retrieval of updated information from the one or more organizations pertaining to qualifications, certifications and/or accreditations of the plurality of individuals is automated such that the up to date information regarding qualifications, certifications and/or accreditations of the individual(s) is recorded in each corresponding identification stored in the data structure.

In an embodiment, establishing an account for the individual further includes prompting the individual to provide the personal image and additional information pertaining to the individual, the additional information including one or more of, location information, additional identification information, and preferences of the individual.

In an embodiment, establishing an account for the individual includes establishing a viewable profile associated with the individual.

In an embodiment, the method further includes, providing account holders with a facility to search for and view profiles associated with other account holders, and wherein the preferences of the individual specify whether a profile associated with the individual, or particular aspects of the profile associated with the individual, should be made available for searching and viewing by other account holders.

In an embodiment, the request from the user to confirm the qualification, certification and/or accreditation of the individual includes an image of the individual based on, the user capturing prior to submitting the request the image of the individual using a device incorporating image capture hardware, and/or the user submitting a document provided by the individual that includes an image of the individual.

In an embodiment, the method further includes, encrypting data received or transmitted by the one or more processors using symmetric and/or asymmetric algorithms to facilitate a secure exchange of data.

In an embodiment, the method further includes, receiving, by one or more processors, a request from the user to establish an account to enable the user to submit a request confirm a qualification, certification and/or accreditation of one or more individuals, and based upon receipt of the request, prompting the user to pay a subscription fee. For example, the computer implemented platform may be accessible to users on a monthly basis according to a paid subscription, and additional revenue may be available by allowing use of the computer implemented platform by advertisers to promote their goods and/or services to individuals and users who engage with the platform.

In another aspect, the present invention provides a computer-implemented system for confirming a qualification, certification and/or accreditation of an individual, the system including one or more processors configured to, receive information from one or more organisations pertaining to qualifications, certifications and/or accreditations of a plurality of individuals whose information is maintained by the organization(s), receive a request from an individual of the plurality of individuals to establish an account, the request including at least one personal image of the individual, process, using one or more facial recognition techniques, the at least one personal image of the individual to determine metrics defining the individual in the personal image provided, establish an identification for the individual based at least on the facial recognition metrics, the identification linking the account established for the individual with the information received from organisations pertaining to qualifications, certifications and/or accreditations associated with the individual, the identification stored in a data structure, receive a request from a user to confirm a qualification, certification and/or accreditation of the individual, the request including an image of the individual, process the request and the image of the individual and utilizing the data structure to locate and retrieve the identification corresponding to the individual, and provide the user with confirmation or otherwise regarding the qualification, certification and/or accreditation of the individual based on the qualification, certification and/or accreditation being recorded in the identification corresponding to the individual.

In yet another aspect, the present invention provides a non-transitory computer-readable medium including computer instruction code that, when executed on a computer, causes one or more processors of the computer to perform the steps of, receiving information from one or more organisations pertaining to qualifications, certifications and/or accreditations of a plurality of individuals whose information is maintained by the organization(s), receiving a request from an individual of the plurality of individuals to establish an account, the request including at least one personal image of the individual, processing, using one or more facial recognition techniques, the at least one personal image of the individual to determine metrics defining the individual in the personal image provided, establishing an identification for the individual based at least on the facial recognition metrics, the identification linking the account established for the individual with the information received from organisations pertaining to qualifications, certifications and/or accreditations associated with the individual, the identification stored in a data structure, receiving a request from a user to confirm a qualification, certification and/or accreditation of the individual, the request including an image of the individual, processing the request and the image of the individual and utilizing the data structure to locate and retrieve the identification corresponding to the individual, and providing the user with confirmation or otherwise regarding the qualification, certification and/or accreditation of the individual based on the qualification, certification and/or accreditation being recorded in the identification corresponding to the individual.

In a yet further aspect, the present invention provides a portable electronic device for use by a user seeking to confirm a qualification, certification and/or accreditation of another individual, the device including, a touch screen configured to receive an input corresponding to a touch operation of the user on an area of the touch screen, and a processor connected to the touch screen, wherein the processor is configured to detect the input to the touch screen and perform operations including, accessing a data structure storing a plurality of identifications that have been established for a plurality of individuals, each identification linking an account established by an individual with information received from organisations pertaining to qualifications, certifications and/or accreditations associated with the individual, detecting a first input, via the touch screen, of a request from the user to confirm a qualification, certification and/or accreditation of the individual, detecting a second input, via the touch screen of an image of the individual uploaded by the user, processing the request and the image of the individual and utilizing the data structure to locate and retrieve the identification corresponding to the individual; and providing, for display on the touch screen, confirmation or otherwise regarding the qualification, certification and/or accreditation of the individual based on the qualification, certification and/or accreditation being recorded in the identification corresponding to the individual.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various system components;

FIG. 2 illustrates a diagram associated with an exemplary server component within the system illustrated in FIG. 1;

FIG. 3 illustrates an exemplary flow diagram of a process that enables users/individuals to download and install a software application, and subsequently access, or register to use, the software application, for interaction with the system illustrated in FIG. 1, including to enable users to retrieve information pertaining to an individual regarding any qualification, certification or accreditation or associated with the individual;

FIG. 4 illustrates a diagram associated with an example interface of the software application that enables individuals to provide a personal image and create a virtual identification;

FIG. 5 illustrates a diagram associated with example interfaces of the software application, including an interface that enables the receipt and processing of a request from a user seeking to confirm the qualification, certification and/or accreditation pertaining to an individual whose image is included in the request, and an interface that confirms the qualification, certification and/or accreditation, or a status thereof; and

FIG. 6 illustrates additional example interfaces of the software application including a payment gateway interface and a chat/alert notification interface.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some methods and structures have not been described in detail to avoid obscuring the present disclosure.

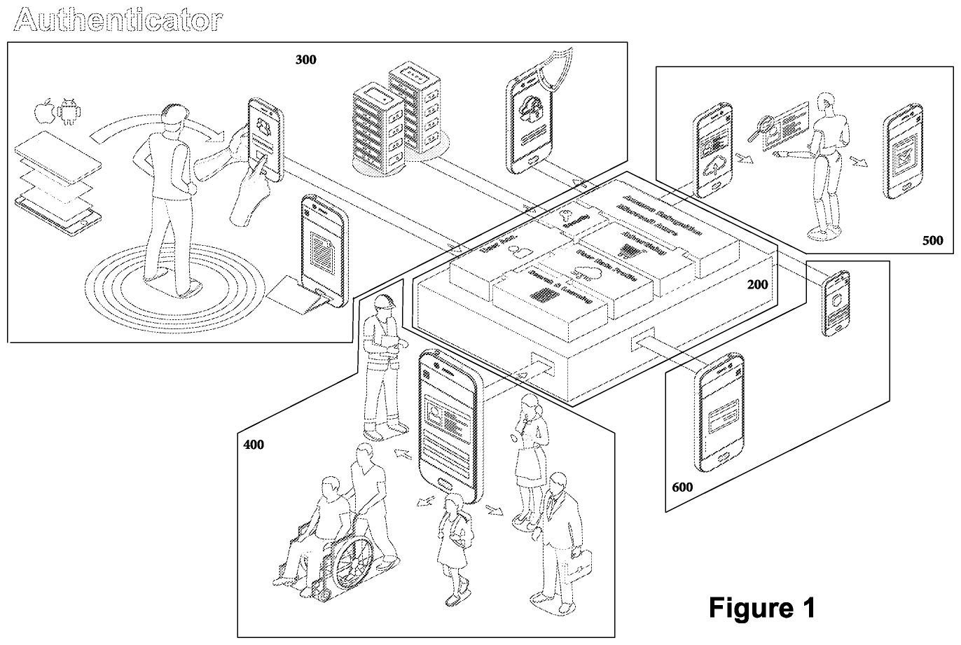

The present invention, according to an embodiment relates to a system and method for authenticating documents pertaining to individuals (30A) and, in particular, providing users (30B) seeking authentication of a qualification, certification and/or accreditation pertaining to the individual (30A) with confirmation (or otherwise) of the qualification, certification and/or accreditation, or a status thereof, as depicted in FIG. 1. Reference to “users (30)” herein is intended to indicate reference to either one or both of the individuals (30A) and/or users (30B). The system and method provide a platform that hosts a computer-executable software application (40), wherein the application (40) is accessible by the users (30), including the individuals (30A) seeking to confirm their qualification, certification and/or accreditation, and users (30B) seeking authentication of the individual's claimed qualification, certification and/or accreditation or a current status thereof. The qualification, certification and/or accreditation may pertain to professional or industry qualifications, police checks, working with children clearance checks, vehicle licences, medical licences, mining certifications, passports, building industry qualifications, real estate licences, sport recreation certifications, firearm licences, etc.

The platform is provided by a central server (20) which maintains one or more processors and/or databases for performing functions, including receiving (e.g. from hardware system (60)) information from one or more organisations pertaining to individuals (30A) regarding any qualification, certification and/or accreditation registered and maintained in respect of the individuals (30A) by each organization, and enabling individuals (30A) to establish an account with the system/platform based upon providing at least one personal image (70). The server (20) is further configured to process the at least one personal image (70) of each individual (30A) to determine facial recognition metrics defining each individual (30A) and creating a virtual identification (80) for each individual (30A). The identification (80) will link the account established for the individual (30A) with information received with respect to the corresponding individual (30A), i.e. the information from organisations pertaining to the individual (30A) regarding any qualification, certification and/or accreditation of the individual (30A). In this way, when a request (90) is received from a user (30B) (the request including an image (85) of a particular individual (30A) seeking to confirm at least one of their qualifications, certifications or accreditations, or a status thereof), the user (30B) may be presented with, in substantially real-time, confirmation (or otherwise) regarding a qualification, certification and/or accreditation recorded against the particular individual (30A) who is the subject of the request (90).

The person skilled in the relevant field of technology will appreciate that the platform provides a solution to existing problems associated with verifying the authenticity of, for example, documents presented to users (30B) by individuals (30A). In one example, a user (30B) may be presented with a vehicle driver's licence associated with an individual (30A), and the platform provides a facility which enables the user (30B) to submit a request which includes a photographic image or copy of the presented licence. The user (30B) may then locate the individual's stored virtual identification (80), compare same against the presented licence, and receive prompt verification regarding the authenticity of the licence. Accordingly, the platform provides users (30B) with the ability to quickly and efficiently verify a stated qualification, certification and/or accreditation which includes information previously awarded to an individual (30A), and/or a status thereof.

In summary, the verification is achieved by firstly retrieving relevant data from hardware systems (60) and processing an image (70) submitted by an individual (30A) to determine metrics defining the individual, retrieved from organizations and to establish a virtual identification (80) associated with the individual (30A). Since the identification (80) is associated with information previously retrieved from organisations regarding a qualification, certification and/or accreditation of the individual (30A), when a request is subsequently received from a user (30B) seeking to verify information presented by the individual (30A), the request information may be utilized to locate the relevant identification (80) pertaining to the individual (30A), and the stated qualification, certification and/or accreditation of the individual (30A) may be confirmed, thereby providing the user (30B) with the ability to verify the authenticity of the received information.

The person skilled in the relevant field of technology will appreciate that the efficiencies that result from the use of such a platform will also give rise to conservation of computer processing, memory and network resources since users (30B) are no longer required to carry out traditional authentication actions which typically require significant operation of computing devices (e.g. use of smartphones to conduct phone calls and search various databases and/or internet websites in order to retrieve relevant information) and which is also likely to give rise to increased instances of human error and/or retrieval of inaccurate information, or information that may not be up to date.

In view of the above practical and useful results that arise from this implementation of the present invention, the use of data communications devices (50) on which the software application (40) is operated in combination with the functionality of server (20) and various associated systems (e.g. hardware systems (60)) represents an improved use of computing resources as compared with conventional computing technology utilised for authentication purposes.

Reference herein to “qualification, certification and/or accreditation” is intended to cover a broad range of achievements associated with an individual (30A), for which the individual (30A) has dedicated time and effort to achieve a goal. For example, a “qualification” may include a broad range of achievements, including addressing all requirements to obtain a vehicle driver licence, completing a tertiary education qualification, etc. Examples of “certification” include tasks for which training has been completed by the individual (30A) and in respect of which a certificate has issued. Examples of “accreditation” include tasks for which all requirements to achieve a particular accreditation status have been satisfied by the individual (30A) (which may not necessarily involve training). The skilled addressee will appreciate that there may be overlap in respect of these three forms of achievement and the scope of the present invention is not intended to be limiting in that regard.

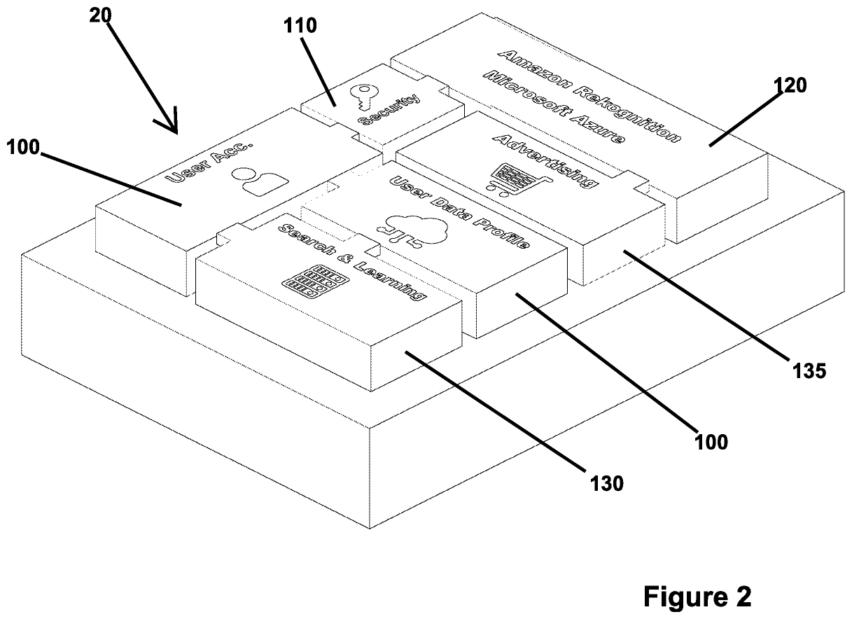

FIG. 1 is divided into segments which are further expanded in subsequent FIGS. 2-6. In particular, Segment 200 of FIG. 1 shows the server component (20) with which a software application (40) operating on data communication devices (50) of individual users (30) are configured to communicate. It will be apparent to the person skilled in the relevant field of technology that the software application (40) may be a mobile application or a web application, and similarly, the device (50) utilised by each user may be a portable device such as a mobile phone or laptop, or alternatively a fixed location device such as a personal computer (not shown). The server component (20) is additionally detailed in FIG. 2.

The skilled person will appreciate that the steps described herein may be executed by the device (50), wherein such operations are facilitated by the software application (40) operating on each device. According to another implementation of the present invention, the server (20) is programmed to provide most or all of the functions described herein particularly where they cannot be provided locally on the user devices (50) or where it may be impractical or not commercially viable to do so. In other words, the steps described herein as performed by the device (50), or components thereof, may be associated with hardware that is located externally of the devices, such as the remote central server (20) for example (i.e. in a distributed architecture). Different arrangements are possible in this regard, and alternate variations will be apparent to the person skilled in the relevant field of technology.

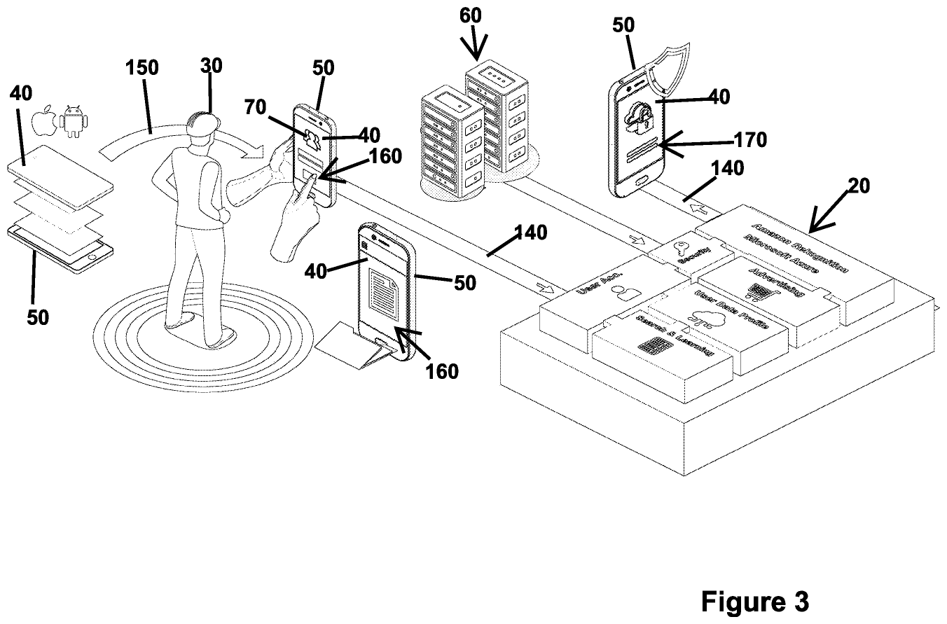

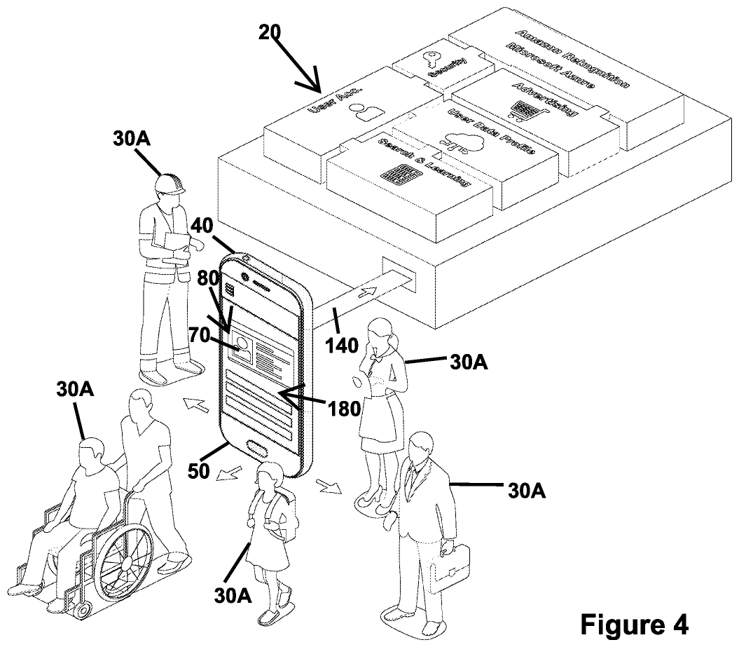

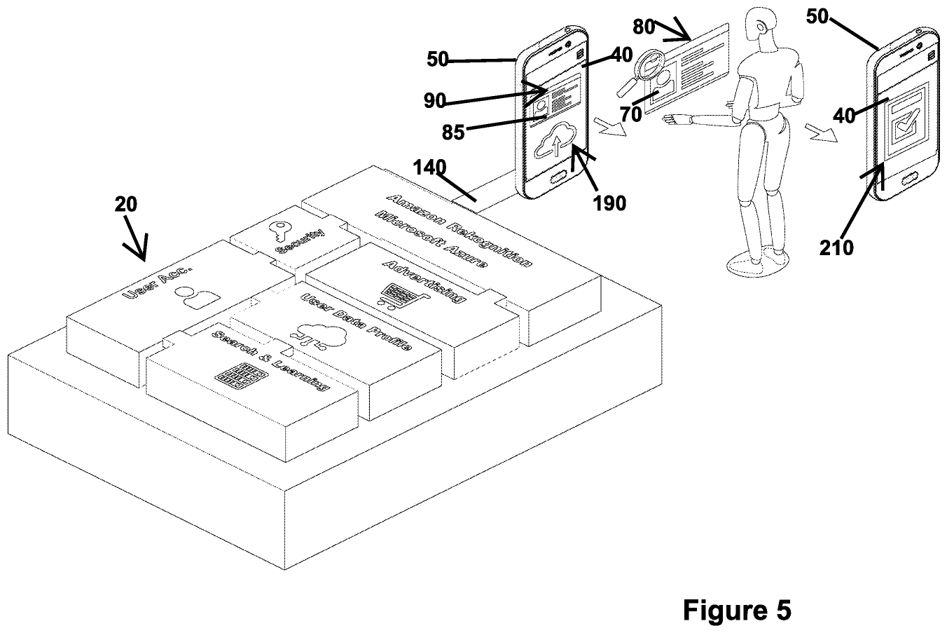

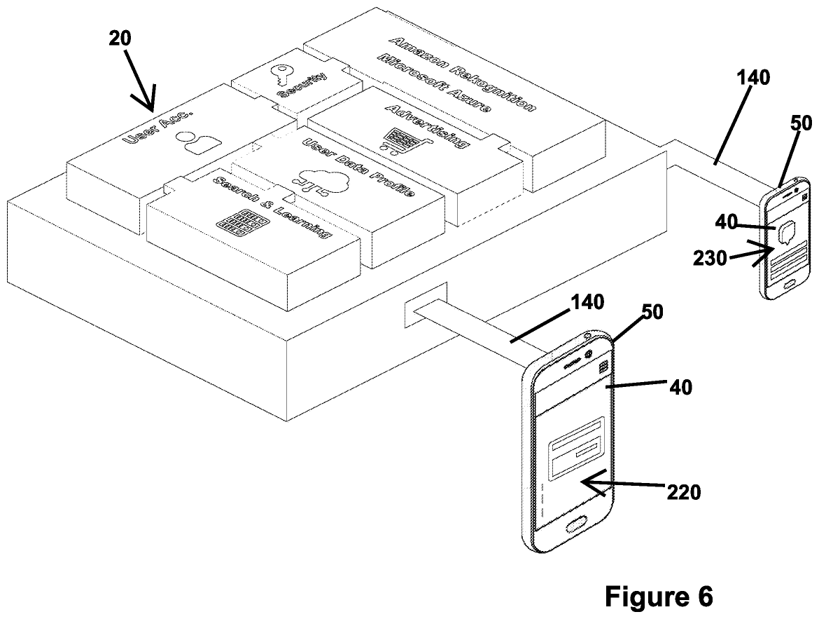

Segment 300 of FIG. 1 shows how the server (20) may be configured for communication with the devices (50) associated with each user (30) as detailed in FIG. 3. In one example, the server (20) may receive data from the devices (50) for the purpose of creating a user profile, e.g. based upon entry of details from the individuals (30A) as well as users (30B). The server (20) may also verify such details. Segment 300 of FIG. 1 also shows a user (30) downloading and installing the application (40) and subsequently accessing the application (40) to establish their account and user profile. Segment 400 of FIG. 1 shows an example (180) interface accessible by a plurality of different individuals (30A) for submitting information and requests, as further detailed in FIG. 4. Segment 500 of FIG. 1 shows example interfaces including interface (190) relating to an authentication process that occurs based upon a request (90) received from a user (30B), i.e. processing an image provided by an individual (30A) to determine metrics defining the individual and thereby providing an identification (80) which will be associated with corresponding information received from organisations regarding a qualification, certification and/or accreditation associated with the individual (30A), and interface (210) which, based upon locating the relevant identification (80) upon receipt of the request (90), provides the user (30B) with confirmation regarding the qualification, certification and/or accreditation, as further detailed in FIG. 5. Segment 600 of FIG. 1 shows additional example interfaces (220) and (230) in which additional functionality associated with the software application (40) may be accessed by each user (30), as further detailed in FIG. 6.

As mentioned above, FIG. 2 shows in greater detail the Segment 200 of FIG. 1 and, in particular, FIG. 2 shows the server component (20) which includes infrastructure upon which the platform of the present invention operates. The infrastructure may be local or cloud-based. The central server (20) may operate one or more computer processors and maintain one or more databases to enable the following functionality and/or storage:
User account and data register (100) storing details relating to registered individuals (30A) as well as registered users (30B) (e.g. name, address, contact details, and any additional detail that may be relevant for the purpose of identifying each user). Additional details which may be stored in the register (100) include personal images (70) provided by individuals (30A) at the time of establishing an account as well as any supporting profile information including additional information or documentation submitted by individuals (30A);
Qualification, certification and/or accreditation retrieval functionality (110) for securely receiving or retrieving documents or information associated with a qualification, certification and/or accreditation or a status thereof, associated with individuals (30A) (e.g. from hardware systems (60));
Data processing functionality (120) for processing functions including processing user input commands and any additional data received for the purpose of generating outputs for display. For example functionality (120) may determine (e.g. using one or more facial recognition algorithms or techniques) metrics defining individuals (30A) based upon their submitted personal images (70) and thereby providing each individual (30A) with an “identification” (80). The data processing functionality (120) may also associate the identification (80) established for individuals (30A) with document(s) retrieved using functionality (110), and to process requests (80) from users (30B) which include images (85) of the individuals (30A) in order to provide confirmation, or otherwise, regarding a stated qualification, certification and/or accreditation of each individual (30A) or a stated status thereof;
Search and learning database (130) for storing details relating to all transactions conducted using the platform including historical/current searches (i.e. requests for authentication) by users (30B), wherein storage of same may facilitate learning/analytics including, for example, machine learning for the purpose of improving verification regarding the existence and authenticity of presented documents (e.g. a machine learning model may be trained to better determine metrics of individuals based upon received photographic images (70), and/or to better process requests from users (30B) including with respect to included imaged (850) and to locate identifications (80) with relevant stored information pertaining to individuals (30A) regarding any qualification, certification and/or accreditation);
Advertising/payment gateway functionality (135) to manage all financial transactions that may be required through the platform including handling the payment of subscription fees as well as managing any advertising-related transactions.

FIG. 2 also depicts that server (20) is configured to enable communication (140) with the devices (50) and, in particular, the software application (40) operating on each device (50). Such communications may occur via the internet or similar network.

FIG. 3 shows in greater detail Segment 300 of FIG. 1 and, in particular, the steps associated with a user (30) (i.e. either one of individuals (30A) or users (30B)) installing (150) the software application (40) on their device (50), and subsequently accessing a user login and registration interface (160) associated with the application (40). Such access may be granted after the user (30) has installed the application (40) which may be achieved by downloading the application (40) from an application store. Each user (30) may create an account (which may include a user profile) using the application (40) and the account/profile information may be stored in the user account and data register (100).

Once each user (30) has accessed the application (40), the user (30) may be presented with one or more further interfaces that the user (30) may utilise to create and maintain their profile and subsequently enable other users to view such information. In the example shown in FIG. 3, the interface (160) is shown from the perspective of an individual (30A), where information is uploaded using the interface (160) including one or more personal images (70) associated with the individual (30A). Where a user (30B) is seeking to access the interface (160) merely to seek to verify the authenticity of document(s) provided by individuals (30A), there is no requirement for the user (30B) to submit their own personal images, etc at the time of creating a profile. Generally, the user profiles may contain basic information about each user including name, age, location, etc., and over time, the user profiles may include additional information such as historical data relating to previous document verifications regarding a qualification, certification and/or accreditation pertaining to an individual (30A), etc.

FIG. 3 also shows an interface (170) representing an example interface for verifying data submitted by each user (30). In this regard, details relating to individuals (30A) as well as users (30B) may undergo a verification process including by comparing submitted details with publicly or privately accessible data including in databases managed by third parties. For example, the server (20) may be configured to interface with such databases using an application program interface (API) or similar.

FIG. 4 shows in greater detail Segment 400 of FIG. 1 and, in particular, an example interface (180) which is accessible by individuals (30A) (FIG. 4 illustrating multiple different types of individuals (30A)), thereby enabling such individuals (30A) to create an identification (80) after personal image(s) (70) submitted by each individual (30A) has been processed to determine metrics defining the individual (30A). In one example, the metrics defining an individual (30A) may be generated using one or more facial recognition algorithms (e.g. Amazon recognition and Microsoft Azura application programming interfaces) configured to analyse portions of the facial image (70) associated with the individual (30A) in order to determine said metrics and to generate the identification (80) associated with the individual (30A). As will become apparent, the identification (80) created for each individual (30A) will also be linked to information received from organisations pertaining to one or more existing qualifications, certifications and/or accreditations of each individual 30(A) which may include details relating to the existence and/or current status of same.

FIG. 5 shows in greater detail Segment 500 of FIG. 1 and, in particular, the process of receiving a request (90) from a user (30B) which includes an image (85) of an individual (30A), as shown in interface (190), and subsequently processing the request (90) and providing confirmation (or otherwise) regarding a particular qualification, certification and/or accreditation associated with the individual (30A). In particular, the identification (80) generated for the individual (30A) is associated with information received or retrieved from one or more organisations pertaining to the individual regarding their qualification, certification and/or accreditation, and upon receipt of a request (90) from a user (30B), the existence of any qualification, certification and/or accreditation associated with the individual (30A) (or a status of same) may be located. In this way, verification regarding the authenticity of information provided by the individual (30A) may be presented to user (30B) in an accurate and efficient (substantially real-time) manner.

The identification (80) created for each individual (30A) may be associated (indexed) with information received or retrieved from organisations pertaining to the individuals (30A) regarding a qualification, certification and/or accreditation by indexing such data utilising a data structure. The data structure may be subsequently searched in order to locate and retrieve relevant identifications (80) stored in the data structure for matching with a received request (90). In particular, details included in a request (90) (eg. any image (85) of the individual (30A) depicted in the request (90)) may be matched with identification information stored in the data structure. In this way, a user (30B) can, substantially in real-time, be presented with an interface (210) which provides a confirmation (or otherwise) regarding the particular qualification, certification and/or accreditation stated by an individual (30A).

This verification process may be useful in a number of different circumstances including, for example, a situation in which a driver license is required to be presented by an individual (30A) to user (30B) for the purpose of identifying the individual (30A). In this regard, the individual's driver license may be scanned (e.g. using camera functionality associated with device (50) of user (30B)) and submitted as part of a request (90) for processing wherein the photo (85) on the licence represents the photo required to accompany the request (90). The user (30B) may subsequently be provided with verification regarding the authenticity of the individual's driver's license in particular verifying that the individual (30A) is qualified to drive. In circumstances where information submitted by an individual (30A) does not include an image (85) of the individual (30A), the user (30B) may utilise their device (50) to capture an image (85) of the individual (30A) and submit same along with the request (90), in order to confirm details regarding any qualification, certification and/or accreditation linked to the individual's profile. There may be circumstances where rather than requiring the existence of a qualification, certification and/or authentication of an individual (30A) to be verified, the status of qualification, certification and/or authentication may be verified. For example, the confirmation received by user (30B) may simply confirm that an existing qualification, certification and/or accreditation remains valid and has not yet expired.

The server (20) may be configured to exchange data with external databases and the like using appropriate encryption techniques. For example, data transferred to and from the server (20) may be encrypted with symmetric and/or asymmetric algorithms to securely exchange data between individuals (30A), users (30B), server (20) and any external systems such as hardware system (60).

The hardware systems (60) or any other external source of information from which data is retrieved regarding a qualification, certification and/or accreditation or status thereof associated with individuals (30A) are likely to be maintained such that the data is up to date and represents the most recently captured data associated with the individuals (30A). In this regard, any details retrieved from such sources may be automated such that the data is retrieved continuously or upon regular predetermined intervals, thereby ensuring that the most up to date information regarding qualifications, certifications and/or accreditations allocated to individuals (30A), or status thereof, may be accessed by the server (20).

FIG. 6 shows in greater detail Segment 600 of FIG. 1 and, in particular, additional example interfaces (220) and (230) of the software application (40), including payment gateway interface (220) and chat/alert notification interface (230). The payment gateway functionality (135) may be utilised to enable users (30), via interface (220) to subscribe to use the software application (40) and pay a subscription fee in respect thereof. In this regard, access may be provided on a monthly basis, for example, according to a paid subscription, and additional revenue may be available to a software administrator (not shown) by allowing use of the platform by advertisers and the like to promote their goods and/or services to users (30) who engage with the platform. In an example implementation, the software application (40) may also be utilized by users (30) to purchase goods and/or services promoted by advertisers.

At the time of registering to use the software application (40), users (30) may be requested to enter their location details and may be requested to authorise the continued monitoring of their location (e.g. as determined by use of GPS functionality associated with user devices (50)). In this regard, advertising, promotions and other offers may be targeted in that the user's current, permanent and/or temporary locations may be utilised for the purpose of providing focused advertising (e.g. goods and/or services available for purchase within a minimum geographical vicinity of each user (30)).

Circumstances may also arise where users (30) may be required to communicate with other users using the software application (40), e.g. communications between individuals (30A) and users (30B), communications between users (30) and an administrator of the software application (40), etc. Interface (220) enables such communications, and further enables alerts and/or notifications to be presented to users (30). An example of an alert that may be presented to a user (30) is a result in response to a request (90) received from a user (30B). In other words, once the relevant processing has been completed by server (20), the device (50) upon which the software application (40) is operating may be caused to present a notification in the form of a confirmation (or otherwise) regarding the particular qualification, certification and/or accreditation associated with an individual (30A). Additional examples of alerts or notifications that may be presented to users (30) include the receipt of a message from another user (30), or when a particular advertiser has offered a new promotion in relation to goods and/or services, etc. Users (30) may be alerted to such notifications by any known means, including by email, SMS or push notification.

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for confirming a qualification, certification and/or accreditation of an individual, the method comprising:
receiving, by one or more processors, information from one or more organisations pertaining to qualifications, certifications and/or accreditations of a plurality of individuals whose information is maintained by the organization(s);
receiving, by one or more processors, a request from an individual of the plurality of individuals to establish an account, the request comprising at least one personal image of the individual;
processing, by one or more processors and using one or more facial recognition techniques, the at least one personal image of the individual to determine metrics defining the individual in the personal image provided;
establishing, by one or more processors, an identification for the individual based at least on the facial recognition metrics,
the identification linking the account established for the individual with the information received from organisations pertaining to qualifications, certifications and/or accreditations associated with the individual,
the identification and associated information stored and indexed in a data structure and automatically updated according to the receipt of updated information from one or more organizations pertaining to qualifications, certifications and/or accreditations of the individuals where information is maintained by the organization(s);
receiving, by one or more processors, a request from a user to confirm a qualification, certification and/or accreditation of the individual, the request comprising an image of the individual and details relating to a qualification, certification and/or accreditation presented to the user by the individual;
processing, by one or more processors, the request comprising the image of the individual and the details relating to a qualification, certification and/or accreditation presented to the user by the individual, and utilizing the data structure to locate and retrieve the identification and associated information corresponding to the individual wherein the identification takes into account any updated information pertaining to qualifications, certifications and/or accreditations of the individual; and
providing, by one or more processors, the user with substantially real-time confirmation or otherwise regarding the qualification, certification and/or accreditation of the individual based on the qualification, certification and/or accreditation recorded for the identification corresponding to the qualification, certification and/or accreditation presented to the user by the individual.

2. A method according to claim 1, wherein the confirmation provided to the user regarding the qualification, certification and/or accreditation confirms the existence and/or current status of the qualification, certification and/or accreditation.

3. A method according to claim 2, further comprising:
based upon confirmation that the qualification, certification and/or accreditation does exist and is currently valid, providing a recommendation to the user to accept the individual's stated qualification, certification and/or accreditation.

4. A method according to claim 2, further comprising:
based on confirmation that the qualification, certification and/or accreditation does not exist and/or is not currently valid, providing a recommendation to the user to reject the individual's stated qualification, certification and/or accreditation.

5. A method according to claim 1, wherein the qualification, certification and/or accreditation pertaining to the individual comprises one or more of:
a professional or industry qualification;
an educational qualification;
a qualification for driving a vehicle;
a police check status;
a working with children clearance check status;
a medical licence;
a mining certification;
a passport status;
a building industry qualification;
a real estate licence; or a sport, recreation and/or firearm licence or certification.

6. A method according to claim 1, wherein the metrics defining the individual in the personal image are generated using one or more facial recognition algorithms.

7. A method according to claim 1, wherein establishing an account for the individual further comprises prompting the individual to provide the personal image and additional information pertaining to the individual, the additional information comprising one or more of:
location information;
additional identification information; or
preferences of the individual.

8. A method according to claim 7, wherein establishing an account for the individual comprises establishing a viewable profile associated with the individual.

9. A method according to claim 8, wherein the method further comprises providing account holders with a facility to search for and view profiles associated with other account holders, and wherein the preferences of the individual specify whether a profile associated with the individual, or particular aspects of the profile associated with the individual, should be made available for searching and viewing by other account holders.

10. A method according to claim 1, wherein the request from the user to confirm the qualification, certification and/or accreditation of the individual comprises an image of the individual based on:
the user capturing prior to submitting the request the image of the individual using a device incorporating image capture hardware, and/or
the user submitting a document provided by the individual that comprises an image of the individual.

11. A method according to claim 1, further comprising encrypting data received or transmitted by the one or more processors using symmetric and/or asymmetric algorithms to facilitate a secure exchange of data.

12. A method according to claim 1, further comprising:
receiving, by one or more processors, a request from the user to establish an account to enable the user to submit a request confirm a qualification, certification and/or accreditation of one or more individuals, and
based upon receipt of the request, prompting the user to pay a subscription fee.

13. A computer-implemented system for confirming a qualification, certification and/or accreditation of an individual, the system including comprising one or more processors configured to:
receive information from one or more organisations pertaining to qualifications, certifications and/or accreditations of a plurality of individuals whose information is maintained by the organization(s);
receive a request from an individual of the plurality of individuals to establish an account, the request comprising at least one personal image of the individual;
process, using one or more facial recognition techniques, the at least one personal image of the individual to determine metrics defining the individual in the personal image provided;
establish an identification for the individual based at least on the facial recognition metrics,
the identification linking the account established for the individual with the information received from organisations pertaining to qualifications, certifications and/or accreditations associated with the individual,
the identification and associated information stored and indexed in a data structure and automatically updated according to the receipt of updated information from the one or more organizations pertaining to qualifications, certifications and/or accreditations of the individual whose information is maintained by the organization(s);
receive a request from a user to confirm a qualification, certification and/or accreditation of the individual, the request comprising an image of the individual and details relating to a qualification, certification and/or accreditation presented to the user by the individual;
process the request comprising the image of the individual and the details relating to a qualification, certification and/or accreditation presented to the user by the individual, and utilizing the data structure to locate and retrieve the identification and associated information corresponding to the individual wherein the identification takes into account any updated information pertaining to qualifications, certifications and/or accreditations of the individual; and
provide the user with substantially real-time confirmation or otherwise regarding the qualification, certification and/or accreditation of the individual based on the qualification, certification and/or accreditation being recorded in the identification corresponding to the qualification, certification and/or accreditation presented to the user by the individual.

14. A non-transitory computer-readable medium comprising computer instruction code that, when executed on a computer, causes one or more processors of the computer to perform the steps of:
receiving information from one or more organisations pertaining to qualifications, certifications and/or accreditations of a plurality of individuals whose information is maintained by the organization(s);
receiving a request from an individual of the plurality of individuals to establish an account, the request comprising at least one personal image of the individual;
processing, using one or more facial recognition techniques, the at least one personal image of the individual to determine metrics defining the individual in the personal image provided;
establishing an identification for the individual based at least on the facial recognition metrics,
the identification linking the account established for the individual with the information received from organisations pertaining to qualifications, certifications and/or accreditations associated with the individual,
the identification and associated information stored and indexed in a data structure and automatically updated according to the receipt of information from one or more organizations pertaining to qualifications, certifications and/or accreditations of the individuals whose information is maintained by the organization(s);
receiving a request from a user to confirm a qualification, certification and/or accreditation of the individual, the request comprising an image of the individual and details relating to a qualification, certification and/or accreditation presented to the user by the individual;
processing the request and the image of the individual and the details relating to a qualification, certification, and/or accreditation presented to the user by the individual, and utilizing the data structure to locate and retrieve the identification and associated information corresponding to the individual, wherein the identification takes into account any updated information pertaining to qualifications, certifications and/or accreditations to the individual; and
providing the user with confirmation or otherwise substantially in real-time regarding the qualification, certification and/or accreditation of the individual based on the qualification, certification and/or accreditation being recorded in the identification corresponding to the qualification, certification and/or accreditation presented to the user by the individual.

15. (canceled)
